(19) United States
(12) Patent Application Publication
(10) Pub. No.: US 2026/0032015 A1
(43) Pub. Date: Jan. 29, 2026

(54) SEMICONDUCTOR DEVICE AND COMMUNICATION SYSTEM

(71) Applicant: ROHM CO., LTD., Kyoto (JP)

(72) Inventor: Kei NAGAO, Kyoto (JP)

(21) Appl. No.: 19/272,180

(22) Filed: Jul. 17, 2025

(30) Foreign Application Priority Data
Jul. 24, 2024 (JP) 2024-118480

(51) Int. Cl. H04L 12/40

(52) U.S. Cl. CPC H04L 12/40058

(57) ABSTRACT

In a semiconductor device, a first receiving section and a first transmitting section are configured to through-output data for a first device included in reception data from a second output terminal when bridge selection data included in the reception data indicates an on state of a through-output in which bit data is output as is; a second transmitting section keeps a signal level of a first output terminal so that a signal of a first bus, which a first transmitting/receiving device uses to receive the reception data from a transmitting device, becomes recessive when the through-output is being performed.

### TECHNICAL FIELD

The present disclosure relates to a semiconductor device.

### BACKGROUND

Semiconductor devices comprising serial communication functions are used in various applications.

Furthermore, an example of circuit technology related to serial communication is disclosed in Patent Document 1.

### PRIOR ART DOCUMENT

### Patent Document

[Patent document 1] Japan Patent Publication No. 2017-224946.

### BRIEF DESCRIPTION OF THE DRAWINGS

FIG. 1 is a diagram showing a configuration of a communication system according to a comparative example.

FIG. 2 is a diagram showing a configuration of a communication system according to an exemplary embodiment of the present disclosure.

FIG. 3 is a diagram showing a configuration of a communication system according to an exemplary embodiment of the present disclosure.

FIG. 4 is a block diagram of a semiconductor device according to an exemplary embodiment of the present disclosure.

FIG. 5 is a table showing an example of bridge mode information.

FIG. 6 is a diagram showing a configuration example of a CAN transceiver.

FIG. 7 is a diagram showing a data configuration of reception data RX when a Write or Read is performed with a semiconductor device 1 as a target device.

FIG. 8 is a diagram showing a configuration example of a communication system according to an embodiment of the present disclosure.

FIG. 9 is a diagram showing a data configuration of reception data RX when a Write or Read is performed with a device 10 as a target device.

FIG. 10 is a diagram showing a timing chart during a Write process for device 10.

FIG. 11 is a diagram showing a configuration of a transmitting section in a semiconductor device 1.

FIG. 12 is a diagram showing a configuration of a signal output section.

FIG. 13 is a diagram showing a timing chart during a Read process for device 10.

FIG. 14 is an external view showing an example of a vehicle.

### DETAILED DESCRIPTION OF THE EMBODIMENTS

Hereinafter, exemplary embodiments of the present disclosure are illustrated with reference to figures.

### 1. COMMUNICATION SYSTEM

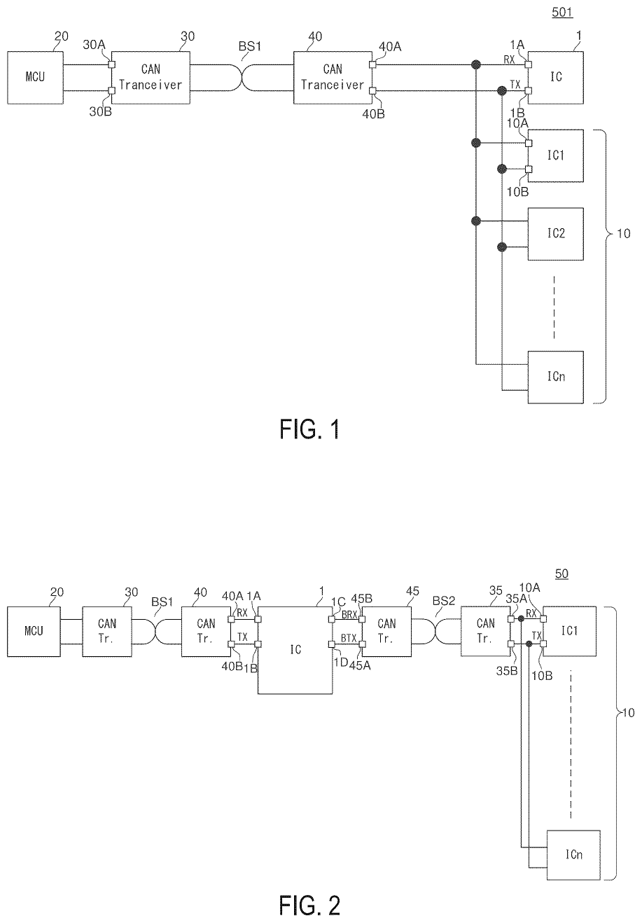

FIG. 1 is a diagram showing a configuration of a communication system 501 according to a comparative example for comparison with embodiments of the present disclosure. The communication system 501 comprises an MCU (Micro Controller Unit) 20, a CAN (Controller Area Network) transceiver 30, a CAN transceiver 40, a semiconductor device 1, and n (n is an integer of 1 or more) devices 10. The communication system 501 is for in-vehicle use, as an example, and the same applies to other communication systems illustrated below.

Between the MCU 20 and the CAN transceiver 30, communication is conducted using UART (Universal Asynchronous Receiver/Transmitter) as a communication method. UART is a format for exchanging serial data between two devices. In UART, bidirectional communication is conducted over two lines between a transmitting side and a receiving side.

Communication between the CAN transceivers 30 and 40 is conducted via a CAN bus BS1. CAN is a serial communication protocol standardized in international standards such as ISO 11898. In CAN, a differential voltage method that transmits data based on a level of a voltage difference generated between two communication lines is used. Communication between the CAN transceiver 40, the semiconductor device 1, and the n devices 10 is conducted via UART.

The CAN transceiver 30 comprises a TXD (Transmission Data Input) terminal 30A and an RXD (Reception Data Output) terminal 30B. The CAN transceiver 30 outputs data input to the TXD terminal 30A to the CAN bus BS1 and outputs data input from the CAN bus BS1 from the RXD terminal 30B.

The CAN transceiver 40 comprises an RXD terminal 40A and a TXD terminal 40B. The CAN transceiver 40 outputs data input to the TXD terminal 40B to the CAN bus BS1 and outputs data input from the CAN bus BS1 from the RXD terminal 40A.

The semiconductor device 1 is an IC (Integrated Circuit) in which circuits for specific functions are integrated, and is configured, for example, as an LED (Light Emitting Diode) driver IC. The n devices 10 are ICs in which circuits for specific functions are integrated, and are configured as, for example, matrix switch ICs.

The semiconductor device 1 comprises an RX (Reception Data Input) terminal 1A and a TX (Transmission Data Output) terminal 1B. The device 10 comprises an RX terminal 10A and a TX terminal 10B. The RX terminal 1A and the n RX terminals 10A are commonly connected to an RXD terminal 40A. The TX terminal 1B and the n TX terminals 10B are commonly connected to a TXD terminal 40B.

In the comparative example shown in FIG. 1, since the semiconductor device 1 and the n devices 10 correspond to the same protocol, the semiconductor device 1 and the n devices 10 can be commonly connected to the same CAN transceiver 40. Reception data RX output from the RXD terminal 40A is input to the RX terminal 1A and the n RX terminals 10A. The reception data RX specifies a device address of either the semiconductor device 1 or one of the n devices 10. Additionally, transmission data TX output from the TX terminal 1B and the n TX terminals 10B is input to the TXD terminal 40B.

However, if the protocols that the semiconductor device 1 and the n devices 10 correspond to are different, it becomes difficult to accommodate the configuration of the comparative example as shown in FIG. 1. Therefore, to solve such issues, embodiments of the present disclosure are implemented as illustrated below. FIG. 2 is a diagram showing a configuration of a communication system 50 according to an exemplary embodiment of the present disclosure. In the communication system 50, CAN transceivers 35 and 45 are provided between the semiconductor device 1 and the n devices 10.

In the configuration shown in FIG. 2, communication via UART is conducted between the CAN transceiver 40 and the semiconductor device 1, between the semiconductor device 1 and the CAN transceiver 45, and between the CAN transceiver 35 and the device 10. The semiconductor device 1 comprises, in addition to the RX terminal 1A and the TX terminal 1B, an RXD (Reception Data Output) terminal 1C and a TXD (Transmission Data Input) terminal 1D. The RX terminal 1A is connected to the RXD terminal 40A of the CAN transceiver 40. The TX terminal 1B is connected to the TXD terminal 40B of the CAN transceiver 40. The reception data RX output from the RXD terminal 40A is input to the RX terminal 1A. The transmission data TX output from the TX terminal 1B is input to the TXD terminal 40B. The reception data RX and the transmission data TX are serial data.

The CAN transceiver 45 comprises an RXD terminal 45A and a TXD terminal 45B. Reception data BRX output from RXD terminal 1C is input to the TXD terminal 45B. Transmission data BTX output from the RXD terminal 45A is input to the TXD terminal 1D. The reception data BRX and the transmission data BTX are serial data.

Communication between the CAN transceiver 45 and the CAN transceiver 35 is conducted via a CAN bus BS2. The CAN transceiver 35 comprises an RXD terminal 35A and a TXD terminal 35B. Each RX terminal 10A of the devices 10 is commonly connected to the RXD terminal 35A. Each TX terminal 10B of the devices 10 is commonly connected to the TXD terminal 35B.

The reception data BRX is output from the RXD terminal 35A via the CAN bus BS2 as the reception data RX and is input to the RX terminal 10A of each device 10. The transmission data TX output from the TX terminal 10B of the devices 10 is output from the RXD terminal 45A via the CAN bus BS2 as the transmission data BTX and is input to the TXD terminal 1D.

In a configuration according to the embodiment of the present disclosure shown in FIG. 2, the semiconductor device 1 and the n devices 10 correspond to different protocols. When the MCU 20 performs a Write or Read on the semiconductor device 1 via the CAN transceivers 30 and 40, the reception data RX output from the RXD terminal 40A to the RX terminal 1A consists only of data corresponding to the protocol of the semiconductor device 1. Furthermore, Write is a process of writing data to a target device, and Read is a process of reading data from the target device. In a case of Read, after receiving the reception data RX, the semiconductor device 1 outputs the transmission data TX from the TX terminal 1B to the TXD terminal 40B.

On the other hand, when the MCU 20 performs a Write or Read on the device 10, the reception data RX output from the RXD terminal 40A to the RX terminal 1A includes data corresponding to the protocol of the device 10. At this time, the semiconductor device 1 turns on a bridge function and through-outputs data corresponding to the protocol of the device 10 included in the reception data RX as reception data BRX from the RXD terminal 1C. Through-output means outputting bit data as is. A device address of the device 10 is specified for the reception data BRX.

In the case of Read, the device 10, which is the target device (device specified by the device address), outputs the transmission data TX from the TX terminal 10B. The transmission data TX is input to the semiconductor device 1 as the transmission data BTX. Since the bridge function is on, the semiconductor device 1 through-outputs the transmission data BTX as transmission data TX from the TX terminal 1B.

As such, according to the embodiment of the present disclosure, even if the protocols of the semiconductor device 1 and the device 10 are different, the CAN transceiver 40 can perform Write and Read on the semiconductor device 1 and the device 10, respectively.

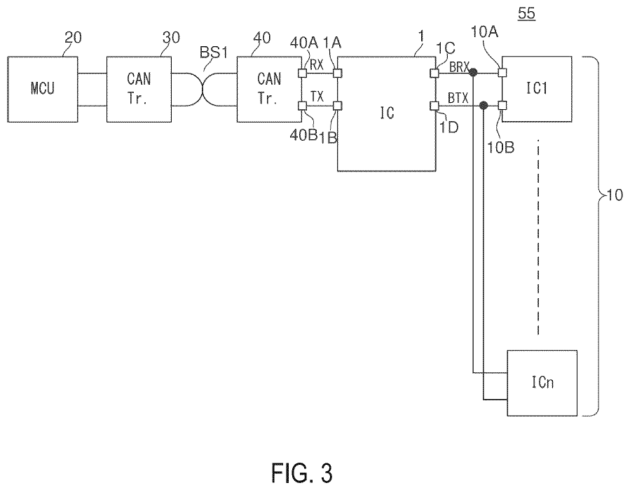

Furthermore, in this embodiment, the configuration is not limited to providing a CAN transceiver between the semiconductor device 1 and the device 10 as described above, and a configuration without a CAN transceiver may also be adopted as shown in FIG. 3. That is, in this case, each RX terminal 10A of the device 10 is commonly connected to the RXD terminal 1C, and each TX terminal 10B of the device 10 is commonly connected to the TXD terminal 1D. As a result, the reception data BRX output from the RXD terminal 1C is input to the RX terminal 10A of each device 10, and the transmission data BTX output from the TX terminal 10B of the device 10 is input to the TXD terminal 1D.

### 2. CONFIGURATION OF SEMICONDUCTOR DEVICE

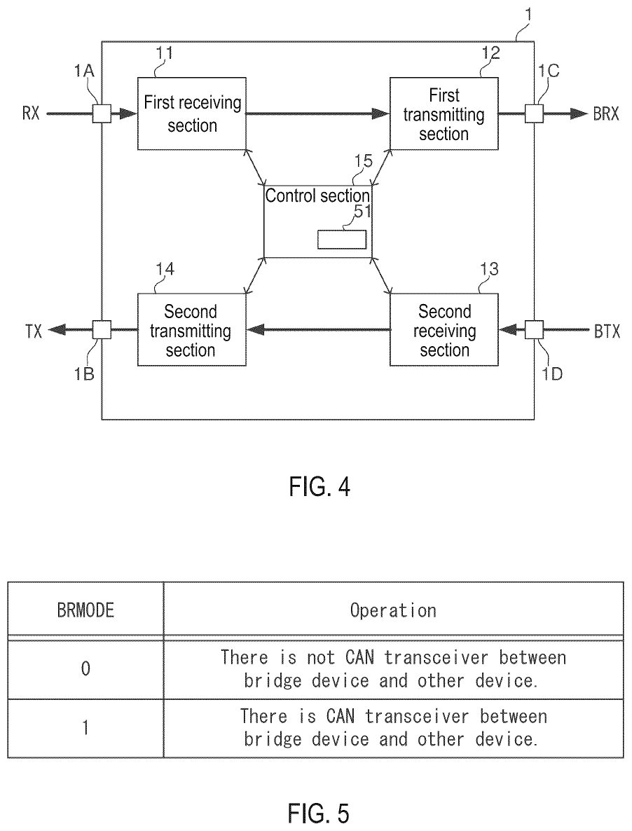

FIG. 4 is a block diagram of a semiconductor device 1 according to an embodiment of the present disclosure. The semiconductor device 1 comprises, as functional blocks, a first receiving section 11, a first transmitting section 12, a second receiving section 13, a second transmitting section 14, and a control section 15. Furthermore, FIG. 4 shows only functional blocks related to communication functions, and may comprise other functional blocks. For example, if the semiconductor device 1 is an LED driver, it may comprise block functions related to LED driving.

The first receiving section 11 receives the reception data RX via the RX terminal 1A. The first transmitting section 12 outputs the reception data BRX via the RXD terminal 1C. The second receiving section 13 receives the transmission data BTX via the TXD terminal 1D. The second transmitting section 14 outputs the transmission data TX via the TX terminal 1B.

The control section 15 controls the first receiving section 11, the first transmitting section 12, the second receiving section 13, and the second transmitting section 14. The control section 15 comprises a register 151.

Furthermore, in this embodiment, it is possible to set whether or not to provide a CAN transceiver between the semiconductor device 1 and the device 10, as described above. Specifically, this can be set using bridge mode information BRMODE. The bridge mode information BRMODE is set in the register 151. An example of the bridge mode information BRMODE is shown in FIG. 5. In the example in FIG. 5, when BRMODE=0, a configuration (FIG. 3) in which a CAN transceiver is not provided between the semiconductor device 1 and the device 10 is set, and when BRMODE=1, a configuration (FIG. 2) in which a CAN transceiver is provided between the semiconductor device 1 and the device 10 is set.

### 3. CONFIGURATION OF CAN TRANSCEIVER

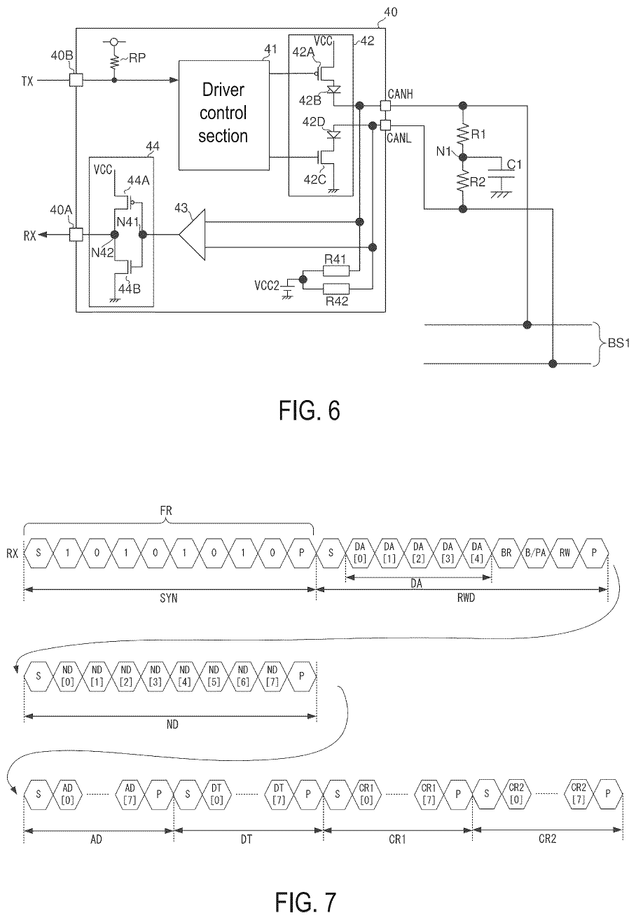

FIG. 6 is a diagram showing a configuration of the CAN transceiver 40. Furthermore, since a configuration of the CAN transceiver 45 is similar to that of the CAN transceiver 40, the CAN transceiver 40 is representatively illustrated herein.

The CAN transceiver 40 comprises a driver control section 41, a driver 42, a receiver 43, and an output section 44. Additionally, the CAN transceiver 40 comprises a TXD terminal 40B, an RXD terminal 40A, a CANH terminal, and a CANL terminal.

The CANH terminal and the CANL terminal are each connected to respective lines of the CAN bus BS1. Between the CANH terminal and the CANL terminal, termination resistors R1 and R2 are connected in series. Resistance values of the termination resistors are defined by ISO 11898, and each of the termination resistors R1 and R2 comprises a 60Q resistor. One end of capacitor C1 is connected to a connection node N1 where the resistors R1 and R2 are connected to each other.

The driver 42 comprises a PMOS transistor (P-channel MOSFET (metal-oxide-semiconductor field-effect transistor)) 42A, a diode 42B, an NMOS transistor (N-channel MOSFET) 42C, and a diode 42D. A source of the PMOS transistor 42A is connected to an application terminal of power supply voltage VCC. A drain of the PMOS transistor 42A is connected to an anode of the diode 42B. A cathode of the diode 42B is connected to the CANH terminal. A source of the NMOS transistor 42C is connected to a ground terminal. A drain of the NMOS transistor 42C is connected to a cathode of the diode 42D. An anode of the diode 42D is connected to the CANL terminal. The diodes 42B and 42D are used to prevent backflow when a surge occurs.

The driver control section 41 controls on/off states of the PMOS transistor 42A and the NMOS transistor 42C based on the transmission data TX input from an outside via the TXD terminal 40B.

More specifically, when the PMOS transistor 42A and the NMOS transistor 42C are in the on-state, a current flowing through the termination resistors R1 and R2 is common, so the voltage drops occurring in each termination resistors R1 and R2 are the same, and high-side signal CANH occurring at the CANH terminal is a voltage higher than a voltage of a connection node N1 (=midpoint voltage) by the amount of the voltage drop, and low-side signal CANL occurring at the CANL terminal is a voltage lower than the voltage of the connection node N1 (=midpoint voltage) by the amount of the voltage drop. In this case, the high-side signal CANH is at a high level, and the low-side signal CANL is at a low level.

Herein, the CANH terminal and the CANL terminal are each connected to an application terminal of a power supply voltage VCC2 via resistors R41 and R42. When the PMOS transistor 42A and the NMOS transistor 42C are in the off-state, a voltage at the connection node N1 gradually approaches the second power supply voltage VCC2 due to an action of the resistors R41 and R42 which have relatively high resistance values. The second power supply voltage VCC2 is a low level of the high-side signal CANH and a high level of the low-side signal CANL, and is the same voltage as the above intermediate voltage.

As such, the transmission data TX input to the TXD terminal 40B is output from the CANH terminal and the CANL terminal to the CAN bus BS1.

Meanwhile, the output section 44 comprises a PMOS transistor 44A and an NMOS transistor 44B. A source of the PMOS transistor 44A is connected to the application terminal of the power supply voltage VCC. A drain of the PMOS transistor 44A is connected to a drain of the NMOS transistor 44B at a node N42. A source of the NMOS transistor 44B is connected to the ground terminal. A voltage of the CANH terminal and a voltage of the CANL terminal are respectively input to the receiver 43. An output terminal of the receiver 43 is connected to a node N41, where a gate of the PMOS transistor 44A and a gate of the NMOS transistor 44B are connected. The node N42 is connected to the RXD terminal 40A.

The receiver 43 applies a high-level or low-level signal to the node N41 according to a differential of input voltages. Thus, the output section 44 outputs a signal obtained by logically inverting the output of the receiver 43 from the RXD terminal 40A to an outside as the reception data RX. As such, data input from the CAN bus BS1 is output from the RXD terminal 40A.

When the high-side signal CANH is at a high level and the low-side signal CANL is at a low level, it is called “dominant,” and when the high-side signal CANH is at a low level and the low-side signal CANL is at a high level, it is called “recessive.” The dominant state takes precedence over the recessive state.

When the transmission data TX is at a high level, the driver 42 sets the signals at the CANH and CANL terminals to recessive; when the transmission data TX is at a low level, the driver 42 sets the signals at the CANH and CANL terminals to dominant. The TXD terminal 40B is pulled up by a pull-up resistor RP within the CAN transceiver 40. As a result, when the transmission data TX is set to high impedance (Hi-Z), the TXD terminal 40B becomes high level, and the signals at the CANH and CANL terminals are set to recessive.

Furthermore, in the case of the CAN transceiver 45, the reception data BRX is input to the TXD terminal 45B, which corresponds to the TXD terminal 40B, and the transmission data BTX is output from the RXD terminal 45A, which corresponds to the RXD terminal 40A. Additionally, the CANH and CANL terminals are connected to the CAN bus BS2.

### 4. CONFIGURATION OF RECEPTION DATA

FIG. 7 is a diagram showing a data configuration of the reception data RX when a Write or Read is performed with the semiconductor device 1 as the target device. The reception data RX shown in FIG. 7 consists only of data corresponding to the protocol of the semiconductor device 1.

In UART, communication is conducted using data units called frames. As shown in FIG. 7, a frame FR comprises bit data from a start bit S to a stop bit P. The start bit S is at a low level, and the stop bit P is at a high level. Between the start bit S and the stop bit P, a predetermined number of bits of bit data are arranged. In an example of FIG. 7, 8 bits of bit data are arranged. That is, the frame FR comprises 10 bits of bit data.

As shown in FIG. 7, the reception data RX comprises, in order from the beginning, a synchronization frame SYN, a Read/Write, etc. frame RWD, a data number frame ND, a register address frame AD, a data frame DT, and CRC (Cyclic Redundancy Check) frames CR1, CR2.

The synchronization frame SYN is bit data for setting a baud rate in the semiconductor device 1.

The Read/Write, etc. frame RWD includes a device address DA, a bridge bit BR, a broadcast/parity bit B/PA, and a Read/Write bit RW. The device address DA is bit data indicating an address of the target device (semiconductor device 1) (5-bit data in the example of FIG. 7). The bridge bit BR is bit data indicating whether a bridge function of the semiconductor device 1 is on or off. The broadcast/parity bit B/PA is bit data indicating whether a broadcast of the semiconductor device 1 is on or off or a parity of the device address DA. The Read/Write bit RW is bit data indicating Read or Write.

Herein, the bridge bit BR=0 indicates that the bridge function is off, i.e., a normal mode (in the reception data RX shown in FIG. 7, the bridge function is off). In this case, the broadcast/parity bit B/PA indicates whether the broadcast is on or off. When the broadcast/parity bit B/PA=0, it indicates that the broadcast is off; when the broadcast/parity bit B/PA=1, it indicates that the broadcast is on.

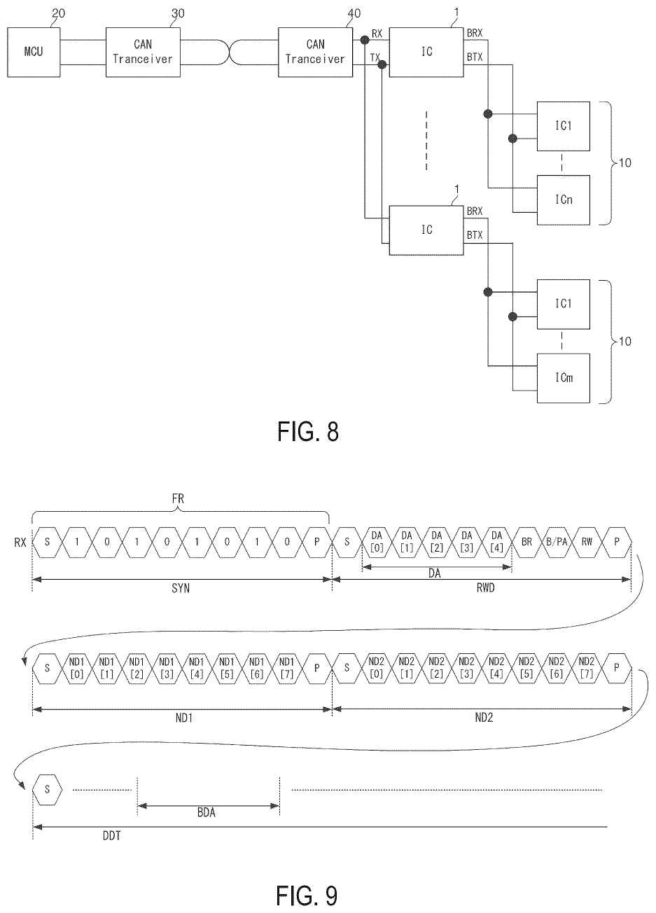

Furthermore, when the broadcast of the semiconductor device 1 is performed, as shown in FIG. 8, multiple semiconductor devices 1 are connected to the CAN transceiver 40. The device 10 is connected to each of the semiconductor devices 1. When the broadcast is on, all of the multiple semiconductor devices 1 become target devices.

The bridge bit BR=1 indicates that the bridge function is on (in the reception data RX shown in FIG. 9 described below, the bridge function is on). In this case, the broadcast/parity bit B/PA becomes the parity of the device address DA. As a result, error detection of the device address DA can be performed. Furthermore, in a configuration shown in FIG. 8, if the protocols differ for each group of devices 10 connected to each of the multiple semiconductor devices 1, when the broadcast of the semiconductor device 1 is turned on, the same reception data RX would be transmitted as the reception data BRX to the devices 10 having different protocols, resulting in incompatibility with the protocols of some devices 10. Therefore, when the bridge function is on, the broadcast is made not to be performed.

The data number frame ND is bit data that indicates a number of frames in the data frame DT.

The register address frame AD is bit data that indicates an address in the register 151. The data frame DT is bit data that indicates a main body of data to be transmitted (data to be written into the register 151) by the reception data RX. Furthermore, in the case of Read, the data frame DT is not included in the reception data RX.

The CRC frames CR1 and CR2 are bit data that indicates error detection codes added to the frames RWD, ND, AD, DT as error detection targets. The 16-bit data of the CRC is divided into two frames CR1 (lower 8 bits) and CR2 (upper 8 bits). Furthermore, in the example shown in FIG. 6, the data frame DT includes one frame, but it may include two or more frames in the reception data RX. In that case, the data frames DT of two or more frames are followed by the CRC frames CR1 and CR2.

FIG. 9 is a diagram showing a data configuration of the reception data RX when a Write or Read is performed with the device 10 as the target device. The synchronization frame SYN and the Read/Write, etc. frame RWD in the reception data RX shown in FIG. 9 are as described above.

In the reception data RX shown in FIG. 9, the Read/Write, etc. frame RWD is followed by a first data number frame ND1 and a second data number frame ND2. The first data number frame ND1 is bit data indicating the total number of frames. The second data number frame ND2 is bit data indicating the number of frames for Write data for the target device (device 10 when using the bridge function). In the case of a Write operation on the target device, the number of frames indicated by the second data number frame ND2 matches the number of frames indicated by the first data number frame ND1. In the case of a Read operation on the target device, the number of frames obtained by subtracting the number of frames indicated by the second data number frame ND2 from the number of frames indicated by the first data number frame ND1 becomes the number of frames of the data (read data) returned from the target device to the semiconductor device 1.

In the reception data RX shown in FIG. 9, the second data number frame ND2 is followed by device data DDT. The device data DDT is data corresponding to the protocol of the device 10 and is the target for through-output as reception data BRX. The device data DDT includes a device address BDA. The device address BDA indicates the address of the target device, the device 10. A position where the device address BDA is arranged in the device data DDT is a position depending on the protocol of device 10.

### 5. THROUGH-OUTPUT CONTROL

Herein, the through-output control by the semiconductor device 1, i.e., the control when the bridge function is on, is described.

### <<in the Case of Write>>

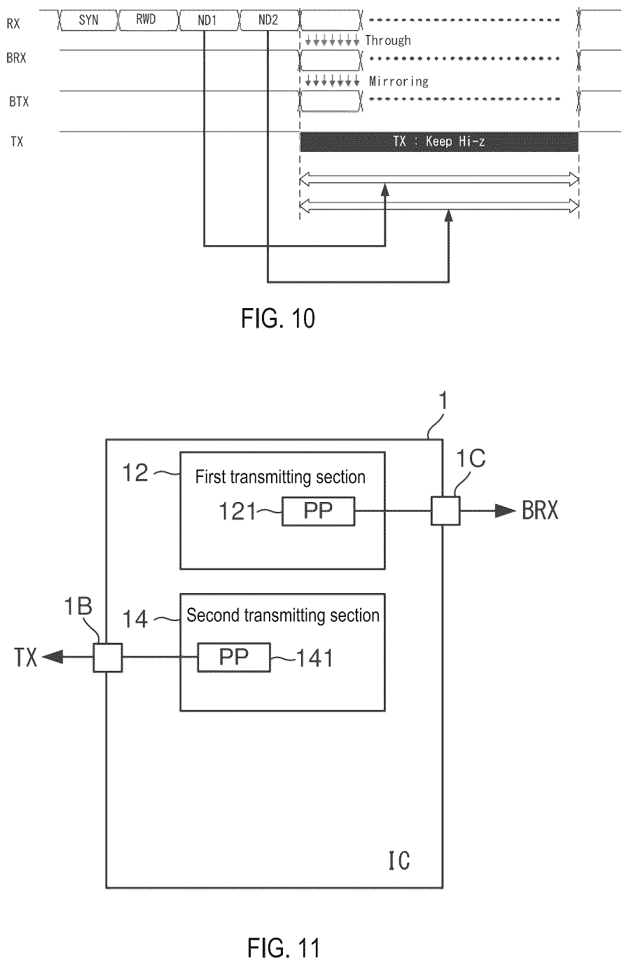

FIG. 10 shows a timing chart during a Write process for device 10. Furthermore, in FIG. 10 (and in FIG. 13 for a Read process described below), in order from top, reception data RX, reception data BRX, transmission data BTX, and transmission data TX are shown. Additionally, in FIG. 10 (and in FIG. 13 for the Read process described below), it is assumed that CAN transceivers 45 and 35 are provided between the semiconductor device 1 and the device 10 (FIG. 2, BRMODE=1).

When the synchronization frame SYN in the reception data RX is received, a baud rate is set by the first receiving section 11, and thereafter, frames are sampled based on the set baud rate. As a result, a bit value (0 or 1) of bit data is obtained.

Subsequently, a Read/Write, etc. frame RWD is received. Regarding the Read/Write, etc. frame RWD, the bridge function is set to on in the bridge bit BR, and Write is set in the Read/Write bit RW.

Subsequently, the first data number frame ND1 and the second data number frame ND2 are received. During the Write process, a number of frames indicated by the first data number frame ND1 matches a number of frames indicated by the second data number frame ND2.

Subsequently, frames (i.e., data SPDT) of the number of frames indicated by the second data number frame ND2 (the number of frames for Write) are through-output as reception data BRX. At this time, the transmission data BRX is input to the TXD terminal 45B of the CAN transceiver 45.

Herein, FIG. 11 is a diagram showing a configuration of the transmitting sections 12 and 14 in the semiconductor device 1. The first transmitting section 12 of the semiconductor device 1 comprises a signal output section 121.

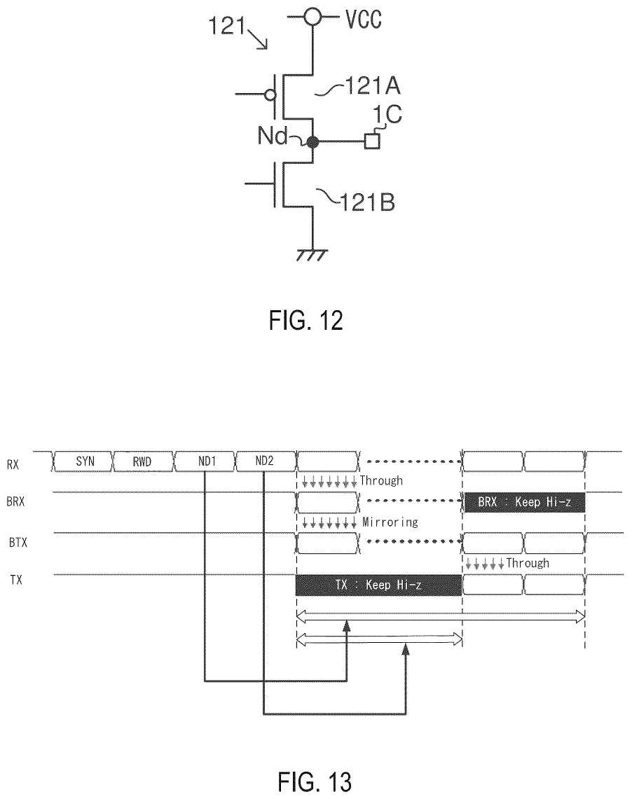

As shown in FIG. 12, the signal output section 121 has a push-pull configuration. Specifically, the push-pull configuration comprises a PMOS transistor (P-channel MOSFET) 121A and an NMOS transistor (N-channel MOSFET) 121B connected in series between a power supply voltage VCC application terminal and a ground potential application terminal. A source of the PMOS transistor 121A is connected to the power supply voltage VCC application terminal, and a drain of the PMOS transistor 121A is connected to a drain of the NMOS transistor 121B at a node Nd. A source of the NMOS transistor 121B is connected to the ground potential application terminal. The RXD terminal 1C is connected to the node Nd. By driving the PMOS transistor 121A and the NMOS transistor 121B on and off, high-level or low-level reception data BRX is output from the RXD terminal 1C.

When the reception data BRX is input to the TXD terminal 45B of the CAN transceiver 45, the CAN bus BS2 is set to recessive on the CAN transceiver 35 side, so the signals of the CANH and CANL terminals corresponding to the reception data BRX are transmitted to the CAN transceiver 35 side. At this time, since the signals of the CANH and CANL terminals are input to the receiver (corresponding to the receiver 43 in FIG. 6) in the CAN transceiver 45, the reception data BRX is mirrored and output as transmission data BTX from the RXD terminal 45A via the receiver and output section (corresponding to the output section 44 in FIG. 6) (FIG. 10).

The transmission data BTX is input to the second receiving section 13. Herein, as shown in FIG. 11, the second transmitting section 14 comprises a signal output section 141. The signal output section 141 has a push-pull configuration similar to the signal output section 121. Transmission data TX is output from the signal output section 141.

Herein, assume that the second transmitting section 14 through-outputs the transmission data BTX as transmission data TX. In this case, the transmission data TX through-output from the signal output section 141 is input to the TXD terminal 40B of the CAN transceiver 40 (FIG. 6). At this time, since reception data RX is being transmitted to the CAN bus BS1 from the CAN transceiver 30 side, a conflict occurs between the transmission data TX and the reception data RX. That is, when the CAN bus BS1 is recessive as reception data RX, the signals at the CANH and CANL terminals may become dominant due to the transmission data TX, potentially altering the reception data RX.

Therefore, in this embodiment, the transmission data TX output from the second transmitting section 14 (signal output section 141) is kept at high impedance (FIG. 10). That is, both the PMOS transistor and the NMOS transistor in the signal output section 141 are in the off state. Since the TXD terminal 40B is pulled up by the pull-up resistor RP (FIG. 6), the TXD terminal 40B is kept at a high level, and the signals of the CANH and CANL terminals are kept at recessive. Thus, a conflict with the reception data RX transmitted from the CAN transceiver 30 side can be avoided.

Furthermore, even in a configuration where no CAN transceiver is provided between the semiconductor device 1 and the device 10 (FIG. 3), the transmission data TX is kept at high impedance when the reception data RX is through-output.

Additionally, if the TXD terminal 40B is not pulled up, the transmission data TX can be kept at a high level by the second transmitting section 14 (signal output section 141).

### <<in the Case of Read>>

FIG. 13 shows a timing chart during a Read process for device 10. In this case, a process up to a point where the reception data RX is through-output is the similar to that of the Write process. In the case of the Read process, after the reception data RX is through-output, the data read from device 10 is output as the transmission data TX. The transmission data TX is input to the semiconductor device 1 as transmission data BTX via the CAN transceivers 35 and 45.

Herein, because the bridge function is on, the second receiving section 13 and the second transmitting section 14 through-output the transmission data BTX as transmission data TX. The through-output of transmission data BTX is performed for a number of frames obtained by subtracting the number of frames indicated by the second data number frame ND2 from the number of frames indicated by the first data number frame ND1.

At this time, the transmission data TX is input to the TXD terminal 40B of the CAN transceiver 40 (FIG. 6), but since the CAN bus BS1 is set to recessive on the CAN transceiver 30 side, the signals of the CANH and CANL terminals corresponding to the transmission data TX are transmitted to the CAN transceiver 30 side. At this time, since the signals of the CANH and CANL terminals are input to the receiver 43, the transmission data TX is mirrored and output as reception data RX from the RXD terminal 40A via the receiver 43 and the output section 44.

Herein, assume that the first transmitting section 12 through-outputs the reception data RX as reception data BRX. In this case, the reception data BRX through-output from the signal output section 121 is input to the TXD terminal 45B of the CAN transceiver 45. At this time, since transmission data BTX is being transmitted to the CAN bus BS2 from the CAN transceiver 35 side, a conflict occurs between the reception data BRX and the transmission data BTX. That is, when the CAN bus BS2 is recessive as transmission data BTX, the signals of the CANH and CANL terminals become dominant due to the reception data BRX, potentially altering the transmission data BTX.

Therefore, in this embodiment, the reception data BRX output from the first transmitting section 12 (signal output section 121) is kept at high impedance (FIG. 13). That is, both the PMOS transistor 121A and the NMOS transistor 121B in the signal output section 121 are in the off state. Since the TXD terminal 45B is pulled up by a pull-up resistor, the TXD terminal 45B is kept at a high level, and the signals of the CANH and CANL terminals are kept at recessive. Thus, conflicts with the transmission data BTX transmitted from the CAN transceiver 35 side can be avoided.

Furthermore, if the TXD terminal 45B is not pulled up in the CAN transceiver 45, the reception data BRX can be kept at a high level by the first transmitting section 12 (signal output section 121).

### <6. Vehicle>

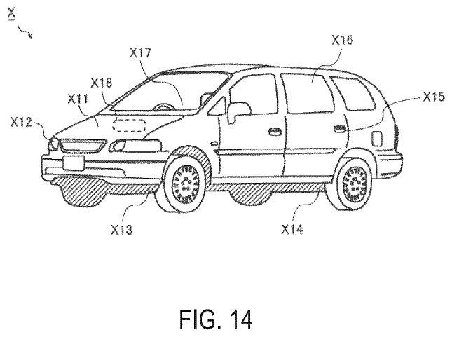

FIG. 14 is an external view showing an example configuration of a vehicle X. The vehicle X of this configuration example is equipped with various electronic equipment X11 to X18 that operate by receiving power supply from an unillustrated battery. Furthermore, mounting positions of the electronic equipment X11 to X18 in FIG. 14 may differ from actual positions for convenience of illustration.

The electronic equipment X11 is an engine control unit that performs control related to an engine (injection control, electronic throttle control, idling control, oxygen sensor heater control, auto cruise control, etc.).

The electronic equipment X12 is a lamp control unit that performs control of turning on and off lights of HID [high intensity discharged lamp], DRL [daytime running lamp], etc.

The electronic equipment X13 is a transmission control unit that performs control related to a transmission.

The electronic equipment X14 is a body control unit that performs control related to a movement of the vehicle X (ABS [anti-lock brake system] control, EPS [electric power steering] control, electronic suspension control, etc.).

The electronic equipment X15 is a security control unit that performs drive control of door locks, security alarms, etc.

The electronic equipment X16 is electronic equipment that is installed in the vehicle X at a time of shipment from a factory as standard equipment or manufacturer option, such as wipers, electric door mirrors, power windows, dampers (shock absorbers), electric sunroofs, electric seats, etc.

The electronic equipment X17 is electronic equipment that is arbitrarily installed in the vehicle X as user options, such as in-vehicle A/V [audio/visual] equipment, a car navigation system, an ETC [electronic toll collection system], etc.

The electronic equipment X18 is electronic equipment that comprises a high-voltage motor, such as an in-vehicle blower, an oil pump, a water pump, a battery cooling fan, etc.

Furthermore, the communication system including the semiconductor device 1 and the device 10 described above may be used to drive any of the electronic equipment X11 to X18.

### <7. Other>

Furthermore, in addition to the above embodiments, the various technical features disclosed in this specification can be modified in various ways without departing from the spirit of the technical creation. That is, the above embodiments should be considered in all respects as illustrative and not restrictive, and the technical scope of the present disclosure should not be limited to the above embodiments but should be understood to include all modifications that fall within the meaning and scope of claims and equivalents.

### 8. Appendix

As described above, a semiconductor device (1) according to one aspect of the present disclosure is configured that the semiconductor device is
connectable via a first transmitting/receiving device (40) capable of communication with an external transmitting device (20) using a differential voltage method, and connectable via a second transmitting/receiving device (45) capable of communication with an external first device (10) using a differential voltage method, comprising:
a first input terminal (1A) configured to be connectable to a first reception data output terminal (40A) of the first transmitting/receiving device;
a first output terminal (1B) configured to be connectable to a first transmission data input terminal (40B) of the first transmitting/receiving device;
a second output terminal (IC) configured to be connectable to a second transmission data input terminal (45B) of the second transmitting/receiving device;
a second input terminal (1D) configured to be connectable to a second reception data output terminal (45A) of the second transmitting/receiving device;
a first receiving section (11) configured to be able to receive serial data (RX) as reception data from the transmitting device via the first input terminal;
a first transmitting section (12) connected to the second output terminal;
a second receiving section (13) connected to the second input terminal; and
a second transmitting section (14) connected to the first output terminal,
wherein the first receiving section and the first transmitting section are configured to through-output data (DDT) for the first device included in the reception data from the second output terminal when bridge selection data (BR) included in the reception data indicates an on state of a through-output in which bit data is output as is, and
the second transmitting section keeps a signal level of the first output terminal so that a signal of a first bus (BS1), which the first transmitting/receiving device uses to receive the reception data from the transmitting device, becomes recessive when the through-output is being performed (first configuration).

According to the above configuration, when the data for the first device is through-output, a conflict with the reception data can be avoided by the first transmitting/receiving device. That is, a semiconductor device that can effectively build a communication system together with a device that uses a communication method different from that of the semiconductor device itself can be provided.

Furthermore, the first configuration may be configured so that the first transmission data input terminal is pulled up, and the second transmitting section keeps the first output terminal at high impedance when the through-output is being performed (second configuration).

Furthermore, the first configuration may be configured so that the first transmission data input terminal is not pulled up, and the second transmitting section keeps the first output terminal at high level when the through-output is being performed (third configuration).

Furthermore, any of the first to third configurations may be configured so that after through-output of the data for the first device, transmission data (BTX) transmitted from the first device via the second transmitting/receiving device is input to the second input terminal, and the second receiving section and the second transmitting section through-output the transmission data from the first output terminal, and
the first transmitting section keeps a signal level of the second output terminal so that a signal of a second bus (BS2), which the second transmitting/receiving device uses to receive the transmission data from the first device, becomes recessive when the transmission data is through-output (fourth configuration).

Furthermore, the fourth configuration may be configured so that the second transmission data input terminal is pulled up, and the first transmitting section keeps the second output terminal at high impedance when the through-output is being performed (fifth configuration).

Furthermore, the fourth configuration may be configured so that the second transmission data input terminal is not pulled up, and the first transmitting section keeps the second output terminal at a high level when the through-output is being performed (sixth configuration).

Furthermore, any of the first to sixth configurations may be configured so that it is possible to set whether or not the second transmitting/receiving device is provided between the semiconductor device and the first device (seventh configuration).

Furthermore, any of the first to seventh configurations may be configured so that the first transmitting/receiving device and the second transmitting/receiving device are configured as CAN transceivers (eighth configuration).

Furthermore, any of the first to eighth configurations may be configured so that communication between the first transmitting/receiving device and the semiconductor device, and communication between the second transmitting/receiving device and the semiconductor device are conducted using UART (ninth configuration).

Furthermore, one aspect of the present disclosure is a communication system (50) comprising the semiconductor device having any of the first to ninth configurations, the transmitting device, the first transmitting/receiving device, the second transmitting/receiving device, and the first device (tenth configuration).

Furthermore, the communication system of the tenth configuration may be set to be mountable in a vehicle (eleventh configuration).

### INDUSTRIAL APPLICABILITY

The present disclosure can be utilized, for example, in communication systems for various applications.

1. A semiconductor device, connectable via a first transmitting/receiving device capable of communication with an external transmitting device using a differential voltage method, and connectable via a second transmitting/receiving device capable of communication with an external first device using a differential voltage method, comprising:
a first input terminal configured to be connectable to a first reception data output terminal of the first transmitting/receiving device;
a first output terminal configured to be connectable to a first transmission data input terminal of the first transmitting/receiving device;
a second output terminal configured to be connectable to a second transmission data input terminal of the second transmitting/receiving device;
a second input terminal configured to be connectable to a second reception data output terminal of the second transmitting/receiving device;
a first receiving section configured to be able to receive serial data as reception data from the transmitting device via the first input terminal;
a first transmitting section connected to the second output terminal;
a second receiving section connected to the second input terminal; and
a second transmitting section connected to the first output terminal,
wherein the first receiving section and the first transmitting section are configured to through-output data for the first device included in the reception data from the second output terminal when bridge selection data included in the reception data indicates an on state of a through-output in which bit data is output as is, and
the second transmitting section keeps a signal level of the first output terminal so that a signal of a first bus, which the first transmitting/receiving device uses to receive the reception data from the transmitting device, becomes recessive when the through-output is being performed.

2. The semiconductor device of claim 1, wherein the first transmission data input terminal is pulled up, and
the second transmitting section keeps the first output terminal at high impedance when the through-output is being performed.

3. The semiconductor device of claim 1, wherein the first transmission data input terminal is not pulled up, and
the second transmitting section keeps the first output terminal at high level when the through-output is being performed.

4. The semiconductor device of claim 1, wherein after through-output of the data for the first device, transmission data transmitted from the first device via the second transmitting/receiving device is input to the second input terminal, and the second receiving section and the second transmitting section through-output the transmission data from the first output terminal, and
the first transmitting section keeps a signal level of the second output terminal so that a signal of a second bus, which the second transmitting/receiving device uses to receive the transmission data from the first device, becomes recessive when the transmission data is through-output.

5. The semiconductor device of claim 4, wherein the second transmission data input terminal is pulled up, and
the first transmitting section keeps the second output terminal at high impedance when the through-output is being performed.

6. The semiconductor device of claim 4, wherein the second transmission data input terminal is not pulled up, and
the first transmitting section keeps the second output terminal at a high level when the through-output is being performed.

7. The semiconductor device of claim 1, wherein it is possible to set whether or not the second transmitting/receiving device is provided between the semiconductor device and the first device.

8. The semiconductor device of claim 1, wherein the first transmitting/receiving device and the second transmitting/receiving device are configured as CAN transceivers.

9. The semiconductor device of claim 1, wherein communication between the first transmitting/receiving device and the semiconductor device, and communication between the second transmitting/receiving device and the semiconductor device are conducted using UART.

10. A communication system, comprising the semiconductor device of claim 1, the transmitting device, the first transmitting/receiving device, the second transmitting/receiving device, and the first device.

11. The communication system of claim 10, which is mountable in a vehicle.
